(19) United States
(12) Patent Application Publication
(10) Pub. No.: US 2019/0088086 A1
(43) Pub. Date: Mar. 21, 2019

(54) LOCATION-AWARE PLAYER LOYALTY SYSTEM

(71) Applicant: Bally Gaming, Inc., Las Vegas, NV (US)

(72) Inventor: Aravind RAJENDRAN, Chennai (IN)

(21) Appl. No.: 16/123,348

(22) Filed: Sep. 6, 2018

Related U.S. Application Data
(60) Provisional application No. 62/560,378, filed on Sep. 19, 2017.

(51) Int. Cl. G07F 17/32; G06Q 30/02; G01C 21/20; G06T 19/00; H04W 4/80

(52) U.S. Cl. CPC G07F 17/3255; G06Q 30/0226; H04W 4/80; G06T 19/006; G01C 21/206

(57) ABSTRACT

Disclosed is an augmented reality customer loyalty system and method including a mobile device. The system allows virtual objects to be associated with real world locations, such as within a casino venue. Location-determination technology within the mobile device is used to present a map showing the relative locations of the device and the virtual objects. An augmented reality mode allows for the representation and acquisition of virtual objects in close proximity to the mobile device. The acquired virtual objects may qualify the customer for certain benefits.

### RELATED APPLICATIONS

This patent application claims the benefit of priority to U.S. Provisional Patent Application Ser. No. 62/560,378, filed on Sep. 19, 2017, the contents of which are hereby incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Field of the Invention

The field of the invention relates to systems and methods directed toward development of customer/user loyalty. More particularly it relates to systems and method which stimulate customer/user interaction within an enterprise, such as a casino enterprise, by determining the location of a user's portable device and providing tailored interactive content and award opportunities based on the determined location.

### 2. The Prior Art

Many enterprises, such as commercial enterprises including chain stores, grocery stores, airlines and casinos strive to engender loyalty and return business with their customers, users or players. It has been known to provide loyalty cards to customers who are, for grocery stores, often entitled to customer discounts. In exchange the store receives customer purchase information for the purpose of business intelligence, marketing and a degree of customer loyalty. Similarly in modern casino enterprises, which may include several physical casino venues, players may enroll in a casino loyalty program. The casino enterprise includes a communication network by which an operator can monitor player activity such as wagers, jackpots, games played and the like. Players are typically identified through the player's use of a loyalty card having a machine readable stripe. For a brick and mortar casino, an example of such a system is the Bally CMSTM system sold by Scientific Games, Inc. of Las Vegas, Nev. These systems interface with card readers at gaming terminals and table game input devices to provide the aforesaid tracking functions. Based upon the data collected, the casino can provide bonuses to players in the way of benefits and incentives to retain a player's loyalty by, for example, awarding “comps” in the form of cash back, discounts for goods, lodging, services and gifts or points which can be exchanged for the foregoing. The tracking can be restricted to a single enterprise venue or can be on a national basis such as described in Boushy, U.S. Pat. No. 7,419,427 issued Sep. 2, 2008 and titled “National Customer Recognition System and Method”, the disclosure of which is incorporated by reference. The level of “comps” available to the player is often related to the player's rating which acts to quantify the value of the player to the casino. A higher rated player is one who spends and gambles more than a lower rated player. A higher rated player is entitled to more valuable or additional comps.

Gaming systems have been designed to promote user loyalty with an enterprise. An example of such player loyalty system is disclosed in U.S. Pat. No. 8,926,425, entitled “System and method for providing loyalty-based virtual objects across various media including gaming devices,” which is assigned to the assignee of the present invention and the disclosure of which is incorporated by reference. For example, the user may obtain a virtual object such as a virtual dog and earn the ability to acquire accessories or upgrades for their virtual dog through interaction with the enterprise. Certain accessories or upgrades may only be acquired or restored at a physical, brick and mortar venue for the enterprise to encourage the user to visit the venue. Acquisition of attributes such as accessories and upgrades may provide a basis for tournaments and prizes. The virtual object may be accessed and displayed at terminals at the venue or at remote devices. Acquisition of such virtual objects may be used to qualify the user for a feature such as a progressive jackpot game.

Pokémon Go is an example of a free-to-play, location-based augmented reality game for iOS and Android mobile devices. The game utilizes the mobile device's GPS ability to locate, capture, battle, and train virtual creatures, called Pokémon, which appear on the mobile device's screen as if they were at the same real-world location as the player. The game popularized location-based and augmented reality technology and often helped local businesses near where the virtual Pokémon were placed.

Many casino enterprises also have a presence in electronic media such as by having commercial web sites and social media sites accessible via the Internet or through broadband communication devices such as cellular telephones, smart phones, tablet computers and other devices. There is an ever growing need to enhance the loyalty of customers/players in addition to offering such existing loyalty programs. There is a need to foster loyalty between players and the enterprise through activity associated with the “brick and mortar” casino venue as well as through associated electronic media. There is further a need to encourage a player or user to return to the brick and mortar physical venue inasmuch as the physical presence at the venue can often lead to the player or user spending money for entertainment, food and beverage, merchandise or other goods and services. There is also a need to provide entertainment in association with the objective of enhancing player loyalty. Entertainment may be by means of compelling graphics and animations, prizes and awards. There is also a desire to expand the use of mobile devices such as smart phones to participate in promoting user loyalty in a casino environment, leveraging existing infrastructure in a way that makes appeals to a modern player. The present invention satisfies these needs, as well as others.

### SUMMARY

There is, therefore, provided, in accordance with one or more aspects of the present invention, improved systems and methods directed toward fostering user loyalty and encouraging repeat visits to a physical venue of an enterprise and providing marketing and advertising opportunities.

Toward this end and according to one aspect of the present invention, improved systems and methods are set forth for an enterprise of the type having at least one physical venue such as a brick and mortar business, resort or casino-resort. Located within the venue are terminals each of which has a video display. For example, a store may have cash-out terminals or user interactive kiosks. In a casino, the terminals may be gaming devices/terminals, interfaces at live table games, kiosks and intra-property portable devices such as gaming tablets. A host server is configured for tracking a user's interaction with terminals. For example, in a store at check-out the cashier terminal or self-checkout terminal interfaces with the host to track use and other data such as items purchased. In a casino venue the host would track the player's gaming at gaming device such as slot machines, video lottery terminals and live table games. Information such as coin-in, jackpots, cash-outs, plays and the like are tracked in casino enterprises. Other commercial activity or commerce such as the purchase of goods and services may be tracked as well. In other business enterprises, the user's purchases, site visits or other interactions, e.g. surveys, inquiries, etc. may be tracked. A communication network provides for communication between the terminals and the host server. A data structure stores a data file for each player/user. The data file may be anonymous and accessible by the anonymous user/player through a personal identification number (PIN) or biometric identifier. The data file may also be for an identified user/player that has enrolled and provided at least identification information. Identifiers such as a PIN or a loyalty card may be used to identify the user/player. The data file may include personal biographical information, electronic funds, promotional credits, loyalty points or the like. In one aspect of the present invention an improvement is provided which includes a data resource storing data corresponding to one or more graphical virtual objects and graphic display packages associated with said object: one or more of the data resource and user's file storing data associating a virtual object with a user. As but some examples, the virtual objects may be gems, gold nuggets, coins, magic eggs, trophies, etc. One or more of the host and a feature server may be configured to store data representing virtual objects awarded to the user.

Furthermore, disclosed herein is a system for providing access to interactive content and/or the acquisition of the aforementioned virtual objects by a user of a portable computing device based upon a determined location of the portable computing device. The system includes a host server, a content server storing data representing the interactive content, and a communication network in communication with the host server and the content server. One or more WiFi communication beacons are in communication with the host server through the communication network. The communication network is configured to establish communication with the portable computing device. The host server is configured to determine a location of the portable computing device from the communication of the portable computing device with the communication network using WiFi signals. The host server is configured to control the content server and enable the portable computing device to display the interactive content and/or allow acquisition of a virtual object when the portable computing device is determined to be in a particular location.

In another embodiment, the system enables the portable computing device (instead of the host server) to determine its location by monitoring WiFi and other wireless signals then displaying appropriate content from locally stored content. In such an embodiment, a network connection or back end server/service is not required for the portable computing device to determine its location. The communications/wireless signal may be WiFi, Bluetooth, zigbee, or any wireless signal (or combinations thereof) from which a signal can be received and a signal strength determined.

In still another embodiment, a method is disclosed of delivering at least augmented reality content to a portable computing device based upon a location of the portable computing device, the portable computing device including communication functionality. The method includes: transmitting communication beacon signals from a plurality of beacons; establishing communication between the portable computing device and the plurality of beacons using the transmitted communication beacon signals; by using WiFi signals, Bluetooth signals, other wireless signals, or combinations thereof, deriving from the communication, using a processor, a location of the portable computing device.

In another aspect of the present invention, the acquisition of objects virtually placed within the venue and in the proximity of the determined location of a user's mobile device may provide a basis for a player to become eligible for certain features or benefits. Data related to the acquisition of such objects may be stored in the above-mentioned player data file. As but an example, where the enterprise is a casino, players may be entitled to various “comps” such as cash, meals or discounts, or may be able to participate in promotions and/or progressive jackpot games after they have acquired one or more virtual objects.

In accordance with one or more embodiments, a gaming system provides for, and a method for using such a system includes steps for, operating a mobile device in conjunction with the gaming system, the mobile device including a camera, position-detection circuitry and a display, assigning a plurality of virtual objects to corresponding locations within the gaming property; notifying a user of the mobile device of an opportunity to obtain the virtual objects; composing a map of the gaming property comprising the virtual objects; displaying the map on the display; and identifying, via the position-detection circuitry, a present location of the mobile device within the gaming property. If the location corresponding to at least one the virtual objects is within a predefined proximity of the present location of the mobile device, capturing a live image of the present location via the camera and augmenting the live image with a representation of the at least one proximal virtual object; displaying the augmented live image on the display; allowing acquisition of the at least one proximal virtual object by the user; and updating a data structure associated with the user to reflect the acquisition.

Further advantages of the disclosed embodiments will be brought out in the following portions of the specification, wherein the detailed description is for the purpose of fully disclosing the various embodiments without placing limitations thereon.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates an example of a player's mobile device displaying a casino map on which the locations of various collectable virtual objects are displayed.

FIG. 2 illustrates an example of a player's mobile device displaying an augmented reality rendering of a collectable virtual object at the player's current location.

FIG. 3 illustrates the steps of a method in accord with at least some aspects of the disclosed concepts.

### DETAILED DESCRIPTION

Persons of ordinary skill in the art will realize that the following description of the present invention is illustrative only and not in any way limiting. Other embodiments of the invention will readily suggest themselves to such skilled persons having the benefit of this disclosure.

Each of the features and teachings disclosed herein can be utilized separately or in conjunction with other features and teachings to provide a system and method to provide user-configurable rules for team play on a single gaming machine. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “configuring,” “determining,” “displaying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

While the present invention is primarily described with reference to a casino enterprise, it should be understood that the present invention and its various embodiments could be extended to other enterprises such as stores, service providers or other businesses which deal with repeat business customers and which desire to foster customer loyalty and entice the customers to return to their brick and mortar venues. In lieu of gaming devices a commercial enterprise would instead have transaction terminals (or interactive sites on the Internet or through broadband communication networks) which track commercial activities, store customer data and provide the features and improvements as hereinafter described.

Some embodiments of the system and method employ location detection technology to deliver experiences that are tailored to a specific location. For example, specific areas of a casino property may include gaming floor, bars, restaurants and shops. In the disclosed embodiments, location awareness technology enables mobile computing devices to acquire information about the device's geographic location. This geographic location information may then be used by the mobile computing device to generate unique gaming establishment experiences based on location, e.g., position in a casino. For example, the location information may be used to provide the basis for an augmented reality display on the mobile computing device. An example of a system and method for obtaining location of a mobile device within a casino may be found in co-owned U.S. Pat. No. 9,721,427, “System and Method for Positionally Accurate Gaming Content,” incorporated herein by reference in its entirety.

Such a system leverages multiple radio receivers that are commonly integrated into modern mobile computing devices (e.g., smart phones, tablets, and the like). Simple coarse location position may be determined by cell tower localization. Where accessible (primarily outdoors), GPS signals may be used. More accurate positional information may be obtained using the Wi-Fi and Bluetooth radio signals of the mobile computing device. Within a casino property, a significant number of Wi-Fi access points typically exist. With their fixed locations, more accurate mobile computing device location can be determined using RSSI and trilateration. For example, in one embodiment, trilateration uses the Received Signal Strength Indication (RSSI) of multiple access points to determine a relative position of the mobile computing device according to its estimated distance from each transmitter. A simpler “proximity” technique (nearest neighbor), which scans for the strongest signal strength, and determines a mobile computing device's coarse position based on the RSSI and fixed geographic location of the transmitting device, may also be employed.

To further improve accuracy, Bluetooth battery powered beacons may be placed at various locations to provide more granular locational signals. Bluetooth low energy beacons are low-cost pieces of hardware—small enough to attach to a wall or countertop—that use battery-friendly, low-energy Bluetooth connections to transmit messages or prompts directly to a smartphone or tablet. Bluetooth 4.0 standard (Bluetooth Low Energy BLE/Bluetooth Smart; short-wavelength UHF radio waves in the ISM band from 2.4 to 2.485 GHz) beacons may be used, for example, USB-powered beacons may be connected directly inside a slot machine or gaming table cabinet. A beacon is identified by a three-part ID, which takes the form of a 128-bit UUID, a 16-bit major, and a 16-bit minor. The UUID is generally shared by all beacons created by the same manufacturer, while the major/minor pair uniquely identifies the beacon within the set of beacons created by that manufacturer. The system maintains a list of beacon ID and their location in the casino.

When a player (i.e. system user or casino patron) enters the casino and enables the mobile application on his or her mobile device, the mobile application downloads a list of beacon ID's and locations for the particular establishment, then continuously cycles through the list and listens for beacon packets containing each beacon's identifying information. When it receives such a packet, it compares the received signal strength of the packet against the power level advertised in the packet, and uses that comparison to estimate the distance to the beacon. By estimating the mobile device's distance from several beacons, triangulation can be used to locate the position of the mobile device on a map of the casino floor.

In other embodiments, other wireless signals and/or protocols may be implemented to determine location. For example, 5 GHz location beacons with another encoding protocol may be used.

The use of position-determination technologies in combination enables positional accuracy in the range of one to two meters. This level of accuracy is sufficient to locate a player/mobile computing device within a specific region of the property. In one embodiment, locations are specific areas of a casino property such as gaming floor, bars, restaurants and shops. By identifying when a player/mobile computing device is in a specific location, displayed content can be modified to provide different opportunities to the player.

In accordance with one or more embodiments, the systems and methods of the present invention may employ the above position-determination techniques augment an existing gaming system, such as Bally Live Floor View™ by Scientific Games, Inc., Las Vegas, Nev. Such as system may be a proprietary analytical system that offers a graphical map to provide an accurate representation of the actual floor layout and slot machines on the casino floor, and Bally Power Loyalty™, which is a point-of-sale system that lets players redeem points, coupons, and comps instantly, not only on the casino floor, but also at retail outlets partnered with the casino. In one embodiment, player's club information is tied into the system to enable the identifying of players that are returning to specific areas and/or playing the same game again. Additionally, to encourage play in certain areas of the casino, the system may allow players to simply occupy or traverse areas of the casino property to obtain different incentives, points, or the like.

In accordance with one or more such embodiments, an augmented reality based mobile application may work in conjunction with property maps displayed by a mobile application that a casino player can directly download onto a mobile phone, tablet or similar device. Such an application may be made available through an “app store” associated with the user's device, for example, the Apple Store™ or Google Play™.

Upon downloading the application and logging in, the application may display a map of a casino in a format compatible with a display of the player's device. Virtual objects associated with (or “placed at”) various locations within the casino also shown on the map. For example, features overlaid at various locations on the map may include representations of dragon eggs, coins, rainbow stones, piggy banks and the like. In one or more embodiments, the system can send push notifications, using, for example, SMS messaging, about various objects within the casino to players' cell phones in order to influence them to travel to the casino. As various virtual objects are claimed by players, the system may be configured to add additional objects to the casino map to, for example, attract players into less busy or more profitable portions of the property.

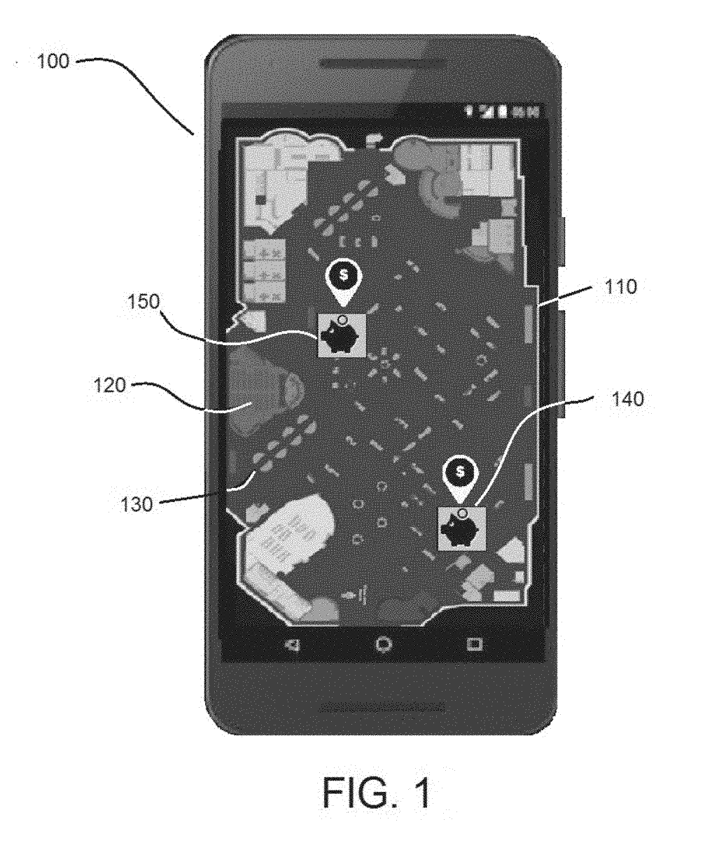

FIG. 1, in accordance with one or more embodiments, provides an illustration of a mobile device 100 on which casino map 110 is displayed. Various locations around the casino are portrayed, for example, theater 120 and banks of slot machines, one example of which is labelled as element 130. Players who wish to claim virtual items, which represent items of value such as player club points, unlocking of certain game features, points in a tournament/competition, or similar, must travel to the casino in person and use their mobile application to navigate to the location of, for example, virtual piggy banks 140 and 150 in order find and obtain them.

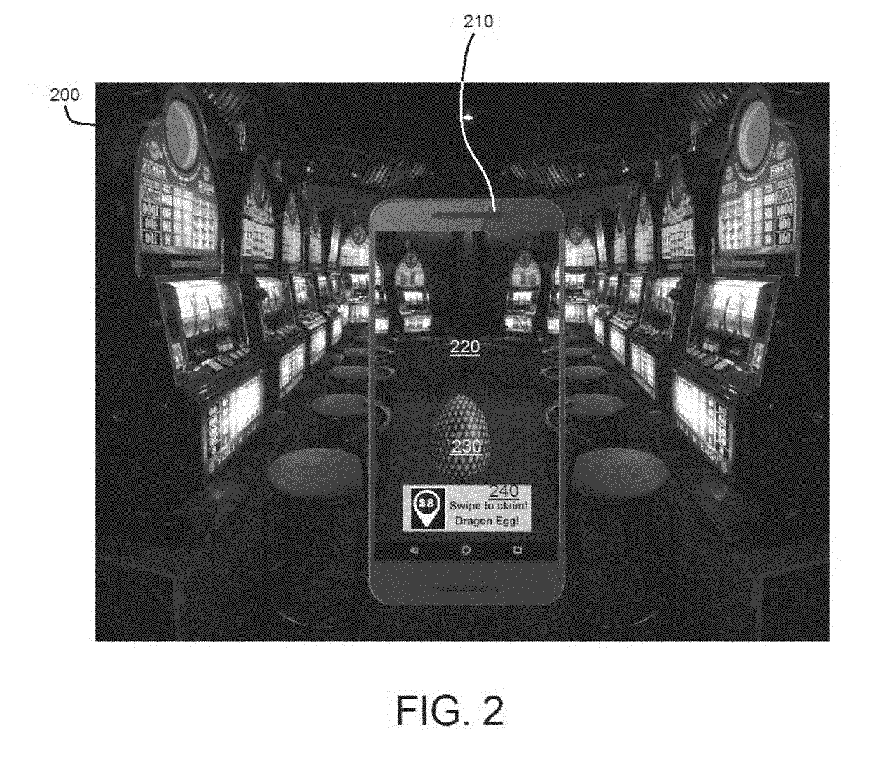

Once close to the location associated with a virtual object, the player, using an augmented reality mode of the application, may view a representative image of the object superimposed over a live camera view of the area of the casino. In accordance with one or more embodiments, FIG. 2 illustrates a mobile device 210 in a live view 200. Augmented reality image 220 includes a partial display of live view 200, typically captured by the mobile device's camera, and a superimposed virtual object, in this case, egg 230. Information 240 about the virtual object such as its value and/or instructions for its acquisition may be provided as part of the augmented reality image 220. In some embodiments, players may take a screen-shot of part or all of augmented reality image 220 and share it on social media.

Once on object is “in sight,” the player may use controls (not shown) such as mechanical or on-screen buttons or swiping gestures provided by the application to “capture” the virtual object and add it to his or her record in their system account. In accordance with other embodiments, once an object has been acquired, there may be a ‘hatch time’ associated with the object before it achieves its full value. For example, the player may be required to linger a requested time within a particular area of the casino to fully complete the acquisition of the object or to increase its value above an initial base value.

In some embodiments, the map of objects and augmented reality view presented to a player may be individually customized for them. For example, players who have already captured an object in a particular area may permanently or temporarily be unable to capture the same object and it will not be displayed on their device. Players who have not captured the object will be able to see the object on the map and in their augmented reality view.

In accordance with one or more embodiments, real-world objects, as opposed to virtual objects, may also be collectable using the virtual reality application. For example, a player may be entered into in a scavenger hunt in which he or she must locate (or locate and play) a certain number of themed slot machines. The locations of the machines in the hunt will appear on the player's map and, when near them, the machines will appear in the augmented reality image with only information (for example, FIG. 2, 240) superimposed on the view. In some embodiments, the machines may be embellished; for example, a glow may surround the target machine.

In some embodiments, the slot machines or objects placed on a player's personalized map or scavenger hunt list may be based on characteristics known to the system to be similar to games the player has previously played, characteristics based on demographic matching, etc. For example, the virtual objects themselves may be themed according to the current interests of each player. For example, one player who is collecting points for a tournament may see a piggy bank on his display, while another player may see the same object as a Leprechaun or a pot of gold. If a player is known to like dogs, he may be enrolled in a dog catcher game in which the object is to hunt virtual dogs for points. Similarly, the values assigned to each object may be player-specific according to their value to the casino or according to other criteria. For example, a “bronze” rated player may receive 10 points for capturing an egg, while a “gold” rated player may get 100 points.

As a player's collection of objects grows, they may become eligible to redeem the collected objects for player points, cash for casino play or any other “comps” or prizes associated with or offered by such a loyalty program. Additionally, players may be enrolled in contests or tournaments related to the collection of objects. In these events, they may compete with one another or play in teams, may be ranked in leader boards, etc.

In addition to the use of collected points within the casino in which they were earned, points from collected objects may also be used as “currency” in a number of related environments. For example, a player may earn “coins” for use in an online interactive game by obtaining an image or otherwise collecting various casino products via their mobile application. For example, if a player scans in a “Goldfish” slot machine bonus screen, they might earn 1,000 coins that can be used to play an online interactive “Goldfish” game. Or if a player scans in a scratched off “Goldfish” lottery ticket, they might earn 250 coins for use in the same interactive game. The coin value may be determined in part by profitability of a given product and the difficulty of obtaining it. Thus, a bonus screen on a slot machine might rank quite highly in virtual coin value, while a scratched off lottery ticket or just a photo of a slot machine in a casino might rank lower.

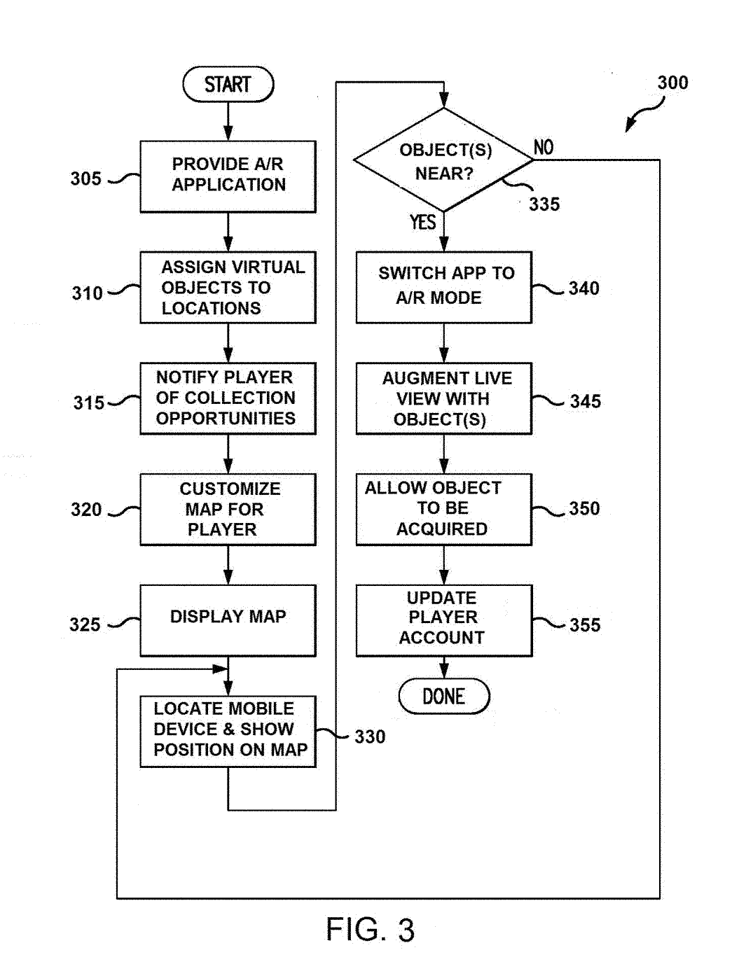

FIG. 3, in accordance with one or more embodiments, represents one method 300 to perform the above described functions associated with obtaining or capturing a virtual object.

At block 305, an augmented reality based mobile application is made available to players either registered with a particular casino's player tracking system or who may simply find the application through an “app store” associated with the user's device, for example, the Apple Store™ or Google Play™

At block 310, the system, either automatically or as configured by its operators, assigns one or more virtual objects to particular locations in the property, for example, theater 120 and bank of slot machines 130 depicted in FIG. 1.

At block 315, the system may inform the player of opportunities to collect the virtual objects by traveling to the casino and capturing them via the augmented reality based mobile application. For example, the player may, upon installing the application, allow the casino to send push notifications, using, for example, SMS messaging, about virtual objects within the casino to the player's cell phone in order to encourage travel to the casino.

At block 320, in accordance with some embodiments, the map is customized for the particular player. For example, the virtual objects may be themed according to the current interests of the player, values assigned to each object may be player-specific according to their value to the casino, and some objects may not appear on the map if the player is not eligible to receive them. At block 325, the player is allowed to view the map on the display of his or her mobile device.

At block 330, once the player has entered the casino and enabled his application, the mobile device uses location awareness technology, as described above, to determine its location within the casino and to display that location on the map.

At block 335, the mobile application determines if any of the virtual objects placed in the casino are in close proximity (i.e. would be visible) to the player. If not, the application continues to update its location in the casino by returning to block 330. If one or more virtual objects are near, the application switches into an augmented reality mode, as previously described with respect to FIG. 2, at block 340.

At block 345, a live view of the area is provided by the mobile device's camera and that image may be overlaid with any objects placed within the current viewing frame. As described above, additional information, labels or instructions related to the objects may also be overlaid to augment the camera image.

At block 350, concluding the method, the player is allowed to capture or otherwise acquire a “visible” virtual object. Once captured, the player's account is updated to reflect the newly acquired object and any points or other privileges may be applied as a result.

As noted above, real-world objects may be substituted for the described virtual objects without deviating from the spirit and scope of the invention.

In accordance with other aspects of the invention, the enterprise may offer advertising opportunities via the augmented reality player loyalty system. For example, a casino may offer to place certain slot machines in an augmented reality scavenger hunt in return for compensation by the manufacturer of the slot machines. Similarly, third party restaurants, shops and the like located within a venue may advertise by paying the casino to place virtual objects in or near their businesses in order to attract potential customers.

While various embodiments have been described above, it should be understood that they have been presented by way of example only, and not limitation. Thus, the breadth and scope of a disclosed embodiment should not be limited by any of the above-described exemplary embodiments, but should be defined only in accordance with the following claims and their equivalents.

What is claimed is:

1. A method of operating a mobile device in conjunction with a gaming system associated with a gaming property, the mobile device comprising a camera, position-detection circuitry and a display, the method comprising:
assigning a plurality of virtual objects to corresponding locations within the gaming property;
notifying a user of the mobile device of an opportunity to obtain the virtual objects;
composing a map of the gaming property comprising the virtual objects;
displaying the map on the display;
identifying, via the position-detection circuitry, a present location of the mobile device within the gaming property;
if the location corresponding to at least one the virtual objects is within a predefined proximity of the present location of the mobile device, capturing a live image of the present location via the camera and augmenting the live image with a representation of the at least one proximal virtual object;
displaying the augmented live image on the display;
allowing acquisition of the at least one proximal virtual object by the user; and
updating a data structure associated with the user to reflect the acquisition.

2. The method of claim 1 wherein the system comprises one or more Bluetooth beacons to enable the position-detection circuitry to identify the present location.

3. The method of claim 1 wherein the system comprises one or more Wi-Fi access points to enable the position-detection circuitry to identify the present location.

4. The method of claim 1 wherein the map is customized based on characteristics of the user.

5. The method of claim 4 wherein the map customization is based on which of the plurality of virtual objects have been acquired by the user.

6. The method of claim 4 wherein the map customization is based on a theme known to be of interest to the user.

7. The method of claim 1 wherein there is a redeemable value associated with each acquired virtual object.

8. The method of claim 7 wherein the redeemable value increases based on an amount of time the user remains at the location.

9. The method of claim 7 wherein the redeemable value is based the user's ranking within a player loyalty system of the gaming property.

10. The method of claim 1 wherein identifying the present location comprises the use of one of trilateration and a nearest neighbor technique.

11. A gaming system associated with a gaming property, the gaming system comprising:
a host server;
a communications network connected to the host server;
a mobile device connected to the communications network, the mobile device comprising a camera, position-detection circuitry and a display;
wherein the host server:
assigns a plurality of virtual objects to corresponding locations within the gaming property;
notifies a user of the mobile device of an opportunity to obtain the virtual objects;
composes a map of the gaming property comprising the virtual objects; and
transmits the map to the mobile device via the communications network; and
wherein the mobile device:
receives the map;
displays the map on the display;
identifies, via the position-detection circuitry, a present location of the mobile device within the gaming property;
if the location corresponding to at least one the virtual objects is within a predefined proximity of the present location of the mobile device, captures a live image of the present location via the camera and augments the live image with a representation of the at least one proximal virtual object;
displays the augmented live image on the display;
allows acquisition of the at least one proximal virtual object by the user; and
transmits information related to the acquisition to the host server via the communications network.

12. The gaming system of claim 11 wherein the system further comprises one or more Bluetooth beacons to enable the position-detection circuitry to identify the present location.

13. The gaming system of claim 11 wherein the system further comprises one or more Wi-Fi access points to enable the position-detection circuitry to identify the present location.

14. The gaming system of claim 11 wherein the map is customized based on characteristics of the user.

15. The gaming system of claim 14 wherein the map customization is based on which of the plurality of virtual objects have been acquired by the user.

16. The gaming system of claim 14 wherein the map customization is based on a theme known to be of interest to the user.

17. The gaming system of claim 11 wherein there is a redeemable value associated with each acquired virtual object.

18. The gaming system of claim 17 wherein the redeemable value increases based on an amount of time the user remains at the location.

19. The gaming system of claim 17 wherein the redeemable value is based the user's ranking within a player loyalty system of the gaming property.

20. The gaming system of claim 11 wherein identifying the present location comprises the use of one of trilateration and a nearest neighbor technique.
